(19) United States
(12) Patent Application Publication
(10) Pub. No.: US 2026/0081454 A1
(43) Pub. Date: Mar. 19, 2026

(54) BATTERY CHARGING AND DISCHARGING SYSTEM, CHARGING TEST METHOD AND DISCHARGING TEST METHOD THEREOF

(71) Applicant: CHROMA ATE INC., Taoyuan City (TW)

(72) Inventors: Bo-Rui XU, Taoyuan City (TW); Kun-Huai JHENG, Taoyuan City (TW); Li-Wei LIU, Taoyuan City (TW)

(21) Appl. No.: 19/237,005

(22) Filed: Jun. 13, 2025

(30) Foreign Application Priority Data
Sep. 13, 2024 (TW) 113134854

(51) Int. Cl. H02J 7/00; H01M 10/44

(52) U.S. Cl. CPC H02J 7/94; H01M 10/441; H02J 7/54; H02J 7/61

(57) ABSTRACT

A battery charging and discharging system includes bidirectional power supply and bypass module. Bidirectional power supply provides a charge current to charge a battery in a charge operation. Bypass module includes a first current path and a second current path that are coupled in parallel to each other. First current path includes a first resistor unit and battery coupled to first resistor unit. Second current path includes a second resistor unit. Charge current is a sum of a first charge current flowing through first current path and a second charge current flowing through second current path. Impedances of first resistor unit and second resistor unit are adjusted to gradually increase and to decrease respectively, so that a current value of first charge current gradually changes from a first current value to zero and a current value of second charge current gradually changes from zero to a second current value.

### CROSS-REFERENCE TO RELATED APPLICATION

This application claims priority to Taiwan Application Serial Number 113134854, filed Sep. 13, 2024, which is herein incorporated by reference in its entirety.

### BACKGROUND

### Field of the Invention

The present disclosure relates to a battery charging and discharging system, a charging test method and a discharge test method thereof. More particularly, the present disclosure relates to a system, a charging test method and a discharge test method thereof for changing currents flowing through two current paths in a bypass module by adjusting impedances of resistor units on the current paths during a battery charge operation or a discharge operation.

### Description of Related Art

During production processes of a battery, in order to ensure product quality, two procedures must be performed: formation and testing. The formation is a process of charging the battery to activate it after the battery is assembled. Testing is a process of repeatedly charging and discharging the battery after battery formation to verify whether a capacity and charge and discharge performance of the battery meet the standard requirements.

The previously used single-cell formation and testing methods, when relying on a single battery charging and discharging device, can only form or test one battery at a time, resulting in low production efficiency. If multiple battery charging and discharging devices are utilized to speed up product formation and testing procedures, it leads higher cost and requires more space. In addition, the single-cell formation and testing method suffers from higher power consumption because the low voltage makes it difficult for the battery's energy to be fed back to the power supply during discharge. Therefore, in recent years, the series charging structure—allowing multiple batteries to be charged and discharged simultaneously—has become the mainstream approach.

However, due to the variations among individual batteries, the batteries cannot complete charging and discharging at the same time. To prevent dangers caused by overcharging or over-discharging of the batteries, a bypass module must be used in the series charging architecture to switch the batteries that have completed charging and discharging, so that the charging and discharging current bypasses these batteries and continues charging and discharging the remaining batteries that have not yet completed charging and discharging. However, an inrush current generated during the switching process can cause damage to circuit components or even batteries.

### SUMMARY

One aspect of the present disclosure provides a battery charging and discharging system. The battery charging and discharging system includes a bidirectional power supply and a bypass module. The bidirectional power supply is configured to provide a charge current to charge a battery in a charge operation. The bypass module is coupled between two terminals of the bidirectional power supply. The bypass module includes a first current path and a second current path that are coupled in parallel to each other. The first current path includes a first resistor unit and the battery coupled to the first resistor. The second current path includes a second resistor unit. The charge current is a sum of a first charge current flowing through the first current path and a second charge current flowing through the second current path, which an impedance of the first resistor unit is adjusted to gradually increase, and meanwhile an impedance of the second resistor unit is adjusted to gradually decrease, so that a current value of the first charge current gradually changes from a first current value to zero, and a current value of the second charge current gradually changes from zero to a second current value at the same time.

In some embodiments, each of the first current value and the second current value is equal to a current value of the charge current.

In some embodiments, in a discharge operation, the bidirectional power supply is further configured to provide a discharge demand instruction to the battery. The battery outputs a discharge current in response to the discharge demand instruction, wherein the discharge current is a sum of a first discharge current flowing through the first current path and a second discharge current flowing through the second current path. The impedance of the first resistor unit is adjusted to gradually increase, and meanwhile the impedance of the second resistor unit is adjusted to gradually decrease, so that a current value of the first discharge current gradually changes from a third current value to zero, and a current value of the second discharge current gradually changes from zero to a fourth current value at the same time.

In some embodiments, each of the third current value and the fourth current value is equal to a current value of the discharge current.

In some embodiments, the first resistor unit includes a first transistor and a second transistor that are coupled in series, and the second resistor unit includes a third transistor and a fourth transistor that are coupled in series.

In some embodiments, the first resistor unit is a first variable resistor, and the second resistor unit is a second variable resistor.

Another aspect of the present disclosure provides a charging testing method of a battery charging and discharging system. The charging testing method is configured for the battery charging and discharging system that has a bidirectional power supply and a bypass module. The bypass module is coupled between two terminals of the bidirectional power supply. The bypass module includes comprises a first current path and a second current path that are coupled in parallel to each other, and the first current path includes a first resistor unit and a battery coupled to the first resistor unit, and the second current path includes a second resistor unit. The charging testing method includes: providing, by the bidirectional power supply, a charge current to charge the battery in a charge operation b, which the charge current is a sum of a first charge current flowing through the first current path and a second charge current flowing through the second current path; and gradually increasing an impedance of the first resistor unit, and gradually decreasing an impedance of the second resistor unit at the same time, so that a current value of the first charge current gradually changes from a first current value to zero, and a current value of the second charge current gradually changes from zero to a second current value at the same time.

In some embodiments, each of the first current value and the second current value in the charging testing method is equal to a current value of the charge current.

Another aspect of the present disclosure provides discharging testing method of a battery charging and discharging system. The discharging testing method is configured for the battery charging and discharging system that has a bidirectional power supply and a bypass module. The bypass module is coupled between two terminals of the bidirectional power supply. The bypass module includes a first current path and a second current path that are coupled in parallel to each other, and the first current path includes a first resistor unit and a battery coupled to the first resistor unit, and the second current path includes a second resistor unit. The discharging testing method includes: providing, by the bidirectional power supply, a discharge demand instruction for the battery; outputting, by the battery, a discharge current in response to the discharge demand instruction, which the discharge current is a sum of a first discharge current flowing through the first current path and a second discharge current flowing through the second current path; and gradually increasing an impedance of the first resistor unit, and gradually decreasing an impedance of the second resistor unit at the same time, so that a current value of the first discharge current gradually changes from a first current value to zero, and a current value of the second charge current gradually changes from zero to a second current value at the same time.

In some embodiments, each of the first current value and the second current value in the discharging testing method is equal to a current value of the discharge current.

Therefore, a main purpose of the present disclosure is to provide a battery charging and discharging method that adjusts switching timing based on characteristics of a transistor to avoid an open circuit in the series charging structure and a battery in short circuit.

### BRIEF DESCRIPTION OF THE DRAWINGS

The present disclosure can be more fully understood by reading the following detailed description of the embodiment, with reference made to the accompanying drawings as follows:

FIG. 1 depicts a schematic diagram of a battery charging and discharging system according to some embodiments of the present disclosure.

FIG. 2 depicts a flow chart of a charging testing method for a battery charging and discharging system according to some embodiments of the present disclosure.

FIG. 3 depicts a schematic diagram of a battery charging and discharging system according to some embodiments of the present disclosure.

FIG. 4A to FIG. 4C depict schematic diagrams corresponding to the battery charging and discharging system in FIG. 3 at different times in a charge test according to some embodiments of the present disclosure.

FIG. 5 depicts a flow chart of a discharging testing method for a battery charging and discharging system according to some embodiments of the present disclosure.

FIG. 6A to FIG. 6C depict schematic diagrams corresponding to the battery charging and discharging system in Fig. at different times in a discharge test according to some embodiments of the present disclosure.

FIG. 7 depicts a schematic diagram of a battery charging and discharging system according to some embodiments of the present disclosure.

FIG. 8A to FIG. 8C depict schematic diagrams corresponding to the battery charging and discharging system in FIG. 7 at different times in a charge test according to some embodiments of the present disclosure.

FIG. 9A to FIG. 9C depict schematic diagrams corresponding to the battery charging and discharging system in FIG. 7 at different times in a charge test according to some embodiments of the present disclosure.

FIG. 10A to FIG. 10D depict schematic diagrams corresponding to the battery charging and discharging system in FIG. 7 at different times in a discharge test according to some embodiments of the present disclosure.

FIG. 11A to FIG. 11D depict schematic diagrams corresponding to the battery charging and discharging system in FIG. 7 at different times in a discharge test according to some embodiments of the present disclosure.

### DETAILED DESCRIPTION

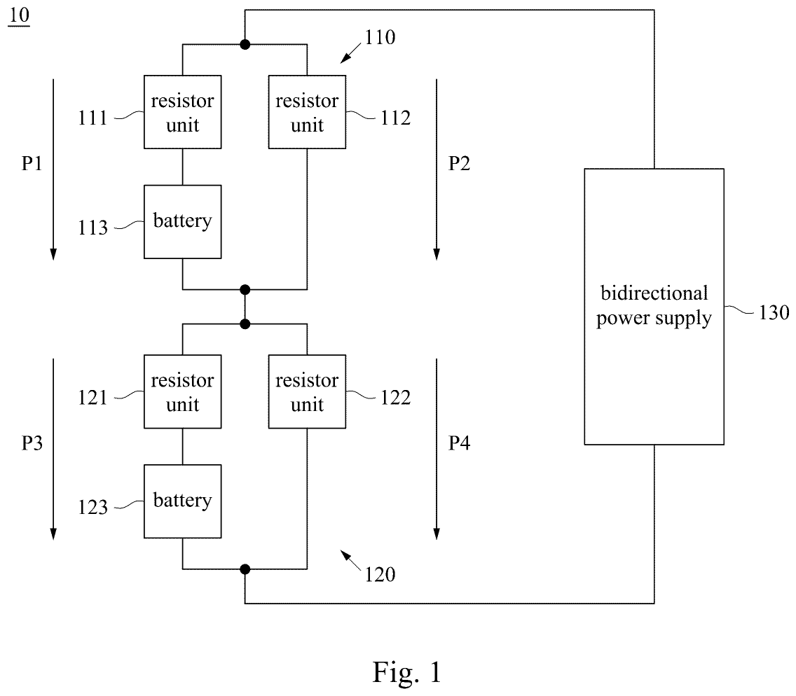

Please refer to FIG. 1. FIG. 1 depicts a schematic diagram of a battery charging and discharging system 10 according to some embodiments of the present disclosure. The battery charging and discharging system 10 includes a bypass module 110, a bypass module 120 and a bidirectional power supply 130. As shown in the embodiment in FIG. 1, the bypass modules 110 and 120 are coupled in series between two terminals of the bidirectional power supply 130.

The bypass module 110 includes current paths P1 and P2 that are coupled in parallel to each other. The current path P1 includes a resistor unit 111 and a battery 113 coupled to the resistor unit 111. The current path P2 includes a resistor unit 112.

Similarly, the bypass module 120 includes current paths P3 and P4 that are coupled in parallel to each other. The current path P3 includes a resistor unit 121 and a battery 123 coupled to the resistor unit 121. The current path P4 includes a resistor unit 122.

In some embodiments, the battery charging and discharging system 10 is configured to perform a charge operation and a discharge operation on the batteries 113 and 123 through the bypass modules 110 and 120 and the bidirectional power supply 130 to test charging and discharging performance of the batteries 113 and 123.

In some embodiments, the battery charging and discharging system 10 is configured to operate the batteries 113 and 123 respectively by switching charge current transmission paths and discharge current transmission paths of the bypass modules 110 and 120. For example, in some embodiments, the battery charging and discharging system 10 is configured to transmit a charge current Ic through the resistor units 111 and 121 to charge the batteries 113 and 123 at the same time. When the battery 113 is fully charged and the battery 123 is not fully charged, in order to prevent the battery 113 from being damaged due to overcharging, the battery charging and discharging system 10 switches the current transmission paths of the bypass module 110, so that the charge current Ic does not flow through the resistor unit 111 but flows through the resistor unit 112. Then, the battery 113 can be removed or other operations can be performed. In other words, through the aforementioned configurations, the battery 123 can maintain its original charging state without being affected by the battery 113 being disconnected from the system. The discharge operation of the battery charging and discharging system 10 on batteries 113 and 123 is similar to the charging operation, and repetitious details are omitted herein.

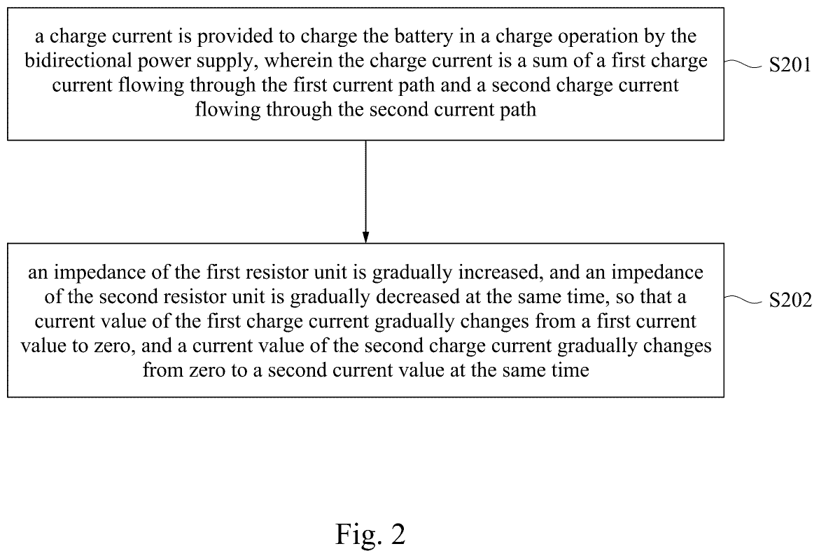

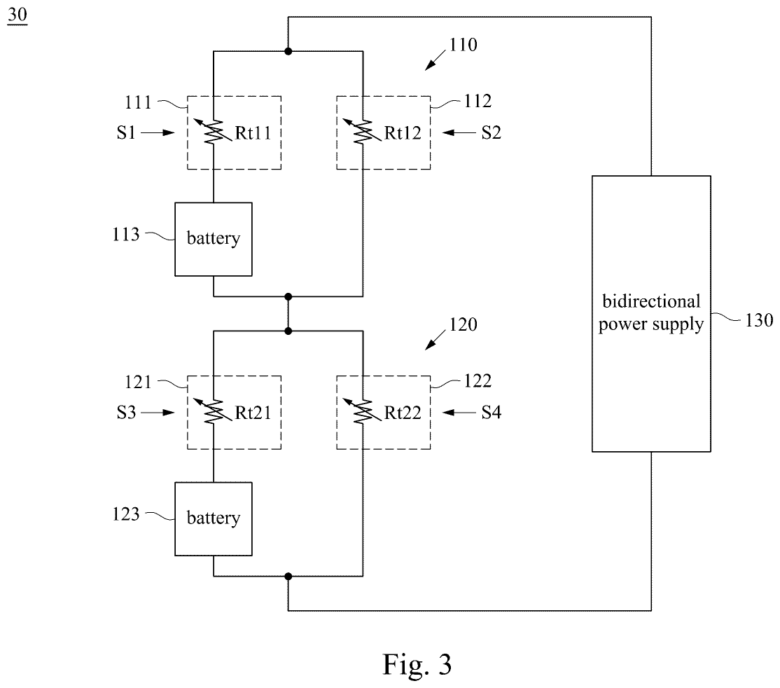

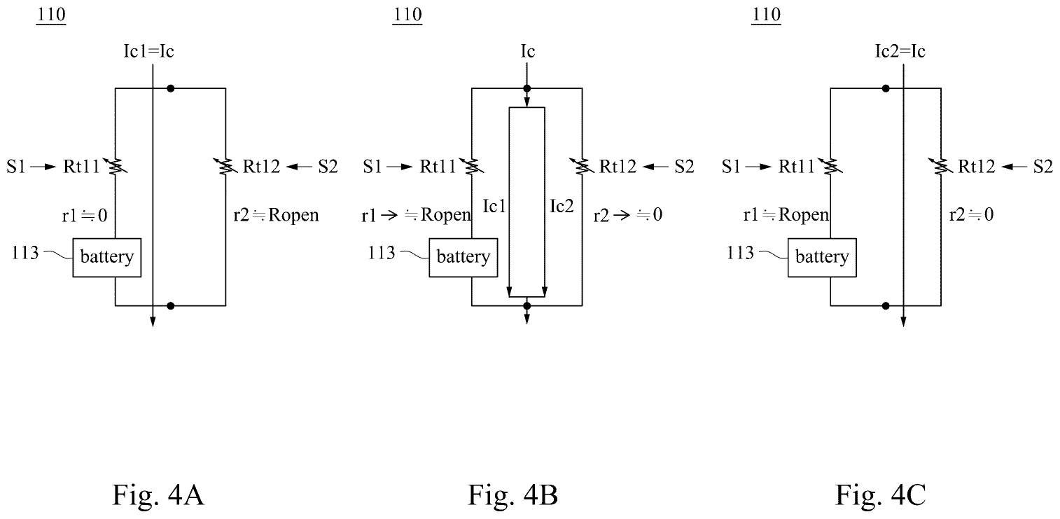

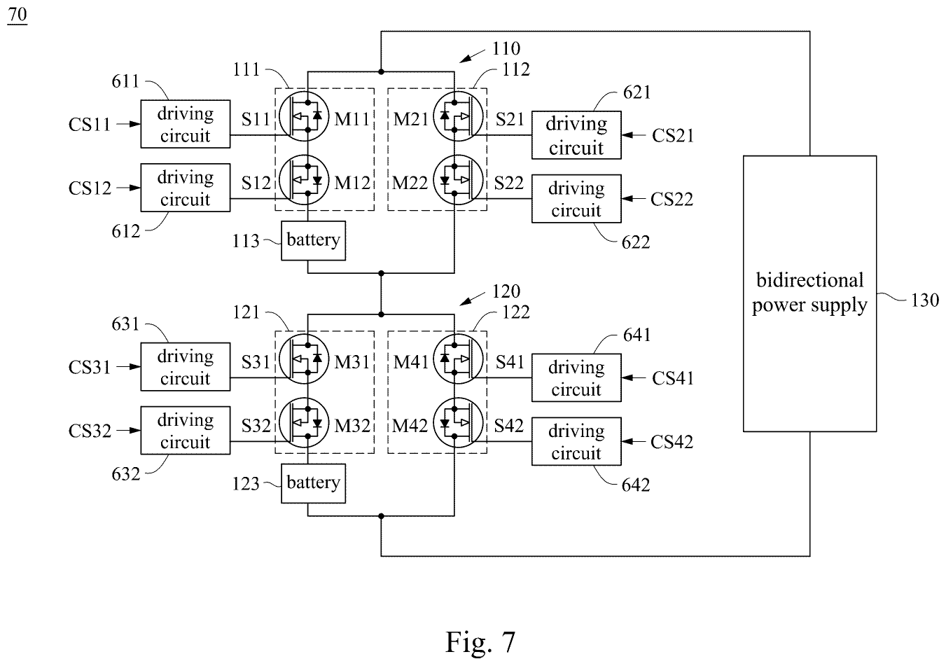

Please refer to FIG. 2. FIG. 2 depicts a flow chart of a charging testing method 200 for a battery charging and discharging system according to some embodiments of the present disclosure. The charging testing method 200, with reference to the embodiments in FIG. 3 and FIG. 4A to FIG. 4C, will be described in following paragraphs of steps S201 and S202. In some embodiments, the charging testing method 200 is also used in a battery charging and discharging system 70 shown in FIG. 7.

Please refer to FIG. 3. FIG. 3 depicts a schematic diagram of a battery charging and discharging system 30 according to some embodiments of the present disclosure. In some embodiments, the battery charging and discharging system 30 is configured with respect to, for example, the battery charging and discharging system 10 in FIG. 1.

As shown in the embodiment in FIG. 3, the resistor units 111 and 112 are a variable resistor Rt11 and a variable resistor Rt12 respectively, and the resistor units 121 and 122 are a variable resistor Rt21 and a variable resistor Rt22 respectively. In some embodiments, the variable resistors Rt11, Rt12, Rt21 and Rt22 have variable impedances responsive to signals S1 to S4 respectively. In some embodiments, the battery charging and discharging system 10 includes a controller (not shown in the figure), which is configured to generate the signals S1 to S4 as control signals according to operation settings of the batteries (e.g. discharging, charging and so on), so as to change the transmission paths of the charge current and the discharge current by adjusting the impedances of the variable resistors Rt11, Rt12, Rt21 and Rt22.

Please refer to FIG. 2 to FIG. 4C at the same time, FIG. 4A to FIG. 4C depict schematic diagrams corresponding to the battery charging and discharging system in FIG. 3 at different times in a charge test according to some embodiments of the present disclosure.

Taking the bypass module 110 as an example, according to the step S201, the bidirectional power supply 130 provides a charge current Ic to charge the battery 113 in the charge operation, in which the charge current Ic is a sum of a charge current Ic1 flowing through the current path P1 and a charge current Ic2 flowing through the current path P2.

Specifically, as shown in FIG. 4A, the variable resistor Rt11 has a low impedance (e.g., approximate to zero), and the variable resistor Rt12 has an extremely high impedance (e.g., similar to open circuit), so that the charge current Ic flows as the charge current Ic1 through the current path P1 to charge the battery 113.

Then, when the battery 113 has been charged to a certain level and needs to be disconnected from the charge current, according to the step S202, as shown in FIG. 4B, the impedance of the variable resistor Rt11 is gradually increased, and the impedance of the variable resistor Rt12 is gradually decreased at the same time, so that a current value of the charge current Ic1 gradually changes from a first current value to zero, and a current value of the charge current Ic2 gradually changes from zero to a second current value at the same time, that is, as shown in FIG. 4C, the charge current Ic flows as the charge current Ic2 flowing through the current path P2. In some embodiments where the battery 113 is fully charged and needs to be disconnected from the charge current, each of the first current value and the second current value is equal to a current value of the charge current Ic.

Compared with some charging testing methods that use a hard switching approach of simultaneously turning off two current paths and then quickly turning on two current paths at the same time, with the aforementioned configurations of the present disclosure, the battery 113 is gradually disconnected from the charge current and slowly apart from a charge loop, suppressing a huge inrush current that occurs at switching to avoid damaging devices in the loop and thereby improving a reliability of each device in the battery charging and discharging system 30.

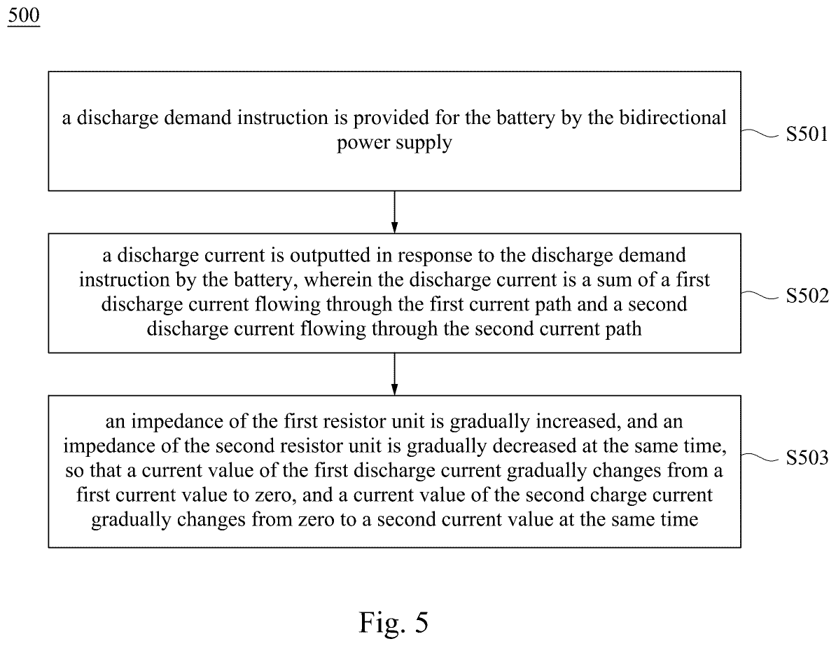

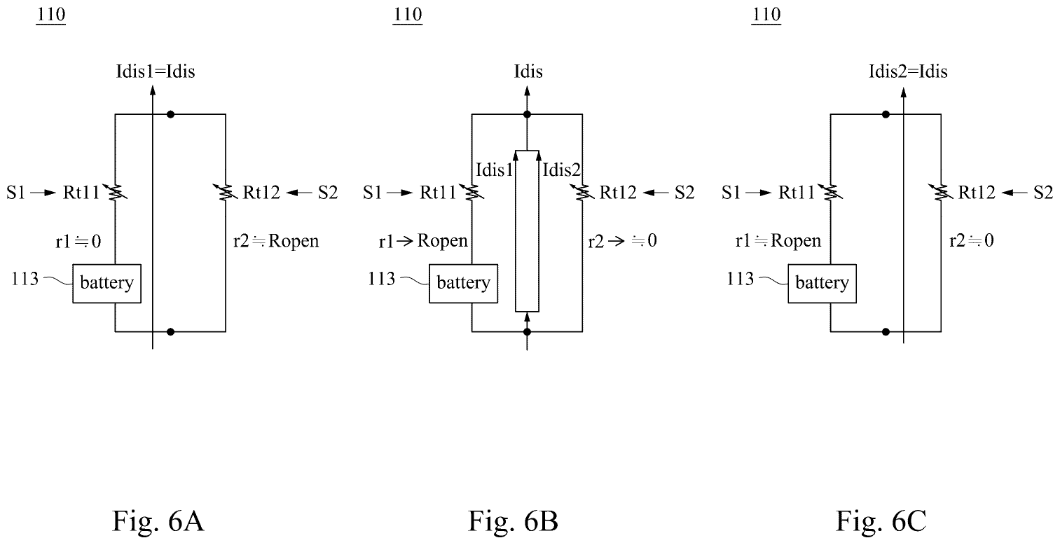

Please refer to FIG. 5. FIG. 5 depicts a flow chart of a discharging testing method 500 for a battery charging and discharging system according to some embodiments of the present disclosure. The discharging testing method 500, with reference to the embodiments in FIG. 1 and FIG. 6A to FIG. 6C, will be described in following paragraphs of steps S501 to S503. In some embodiments, the discharging testing method 500 is also used in the battery charging and discharging system 70 shown in FIG. 7.

For example, according to the step S501, the bidirectional power supply 130 provides a discharge demand instruction for the battery 113. Then, in the step S502, the battery 113 outputs a discharge current Idis in response to the discharge demand instruction, wherein the discharge current Idis is a sum of a discharge current Idis1 flowing through the current path P1 and a discharge current Idis2 flowing through the current path current path P2.

As shown in FIG. 6A, the variable resistor Rt11 has a low impedance, and the variable resistor Rt12 has an extremely high impedance, so that the discharge current Idis flows as the discharge current Idis1 flowing through the current path P1.

Then, when the battery 113 has been discharged to a certain level and needs to be disconnected from the discharge current, according to the step S503, as shown in FIG. 6B, the impedance of the variable resistor Rt11 is gradually increased, and the impedance of the variable resistor Rt12 is gradually decreased at the same time, so that a current value of the discharge current Idis1 gradually changes from a third current value to zero, and a current value of the discharge current Idis2 gradually changes from zero to a fourth current value that is, as shown in FIG. 6C, the discharge current Idis flows as the discharge current Idis2 flowing through the current path P2. In some embodiments where the battery 113 is fully discharged needs to be disconnected from the discharge current, each of the third current value and the fourth current value is equal to a current value of the discharge current Idis.

In other embodiments, the resistor units 111, 112, 121 and 122 are implemented by transistors. Please refer to FIG. 7. FIG. 7 depicts a schematic diagram of a battery charging and discharging system 70 according to some embodiments of the present disclosure. In some embodiments, the battery charging and discharging system 70 is configured with respect to, for example, the battery charging and discharging system 10 in FIG. 1.

As shown in FIG. 7, the resistor unit 111 in the battery charging and discharging system 70 includes transistors M11 and M12 that are coupled in series to each other. The resistor unit 112 includes transistors M21 and M22 that are coupled in series to each other. The resistor unit 121 includes transistors M31 and M32 that are coupled in series to each other. The resistor unit 122 includes transistors M41 and M42 that are coupled in series to each other. In some embodiments, the transistors M11, M12, M21, M22, M31, M32, M41 and M42 are N-type Metal-Oxide-Semiconductor Field-Effect Transistor (MOSFET).

Specifically, source terminals of the transistors M11 and M12 are coupled to each other. A drain terminal of the transistor M12 is coupled to one terminal of the battery 113. Drain terminals of the transistors M11 and M21 are coupled to each other and coupled to the bidirectional power supply 130. Source terminals of the transistors M21 and M22 are coupled to each other. A drain terminal of the transistor M22 is coupled to the other terminal of the battery 113 and the bypass module 120. Similarly, source terminals of the transistors M31 and M32 are coupled to each other. A drain terminal of the transistor M32 is coupled to one terminal of the battery 123. Drain terminals of the transistors M31 and M41 are coupled to each other and coupled to the bypass module 110. Source terminals of the transistors M41 and M42 are coupled to each other. A drain terminal of the transistor M42 is coupled to the other terminal of the battery 123 and coupled to the bidirectional power supply 130.

The battery charging and discharging system 70 further includes driving circuits 611, 612, 621, 622, 631, 632, 641 and 642. In some embodiments, the driving circuits 611 and 612 generate signals S11 and S12 in response to signals CS11 and CS12 respectively to control the transistors M11 and M12. Similarly, the driving circuits 621 and 622 generate signals S21 and S22 in response to signals CS21 and CS22 respectively to control the transistors M21 and M22; the driving circuits 631 and 632 generate signals S31 and S32 in response to signals CS31 and CS32 respectively to control the transistors M31 and M32; and the driving circuits 641 and 642 generate signals S41 and S42 in response to signals CS41 and CS42 respectively to control the transistors M41 and M42.

In some embodiments, the battery charging and discharging system 70 includes a controller(not shown in the figure), which is configured to generate the signals CS11, CS12, CS21, CS22, CS31, CS32, CS41 and CS42 as control signals according to operation settings (e.g. charging, discharging and so on)of batteries on a system. The driving circuits 611, 612, 621, 622, 631, 632, 641 and 642 are configured to delay and modulate the corresponding ones of the signals CS11, CS12, CS21, CS22, CS31, CS32, CS41 and CS42 to generate signals S11, S12, S21, S22, S31, S32, S41 and S42 that can adjust a resistance of each of transistors required at a specific time, thereby changing the transmission paths of the charge current and the discharge current in the battery charging and discharging system 70. In some embodiments, the driving circuits 611, 612, 621, 622, 631, 632, 641 and 642 can be implemented with any suitable delay circuit.

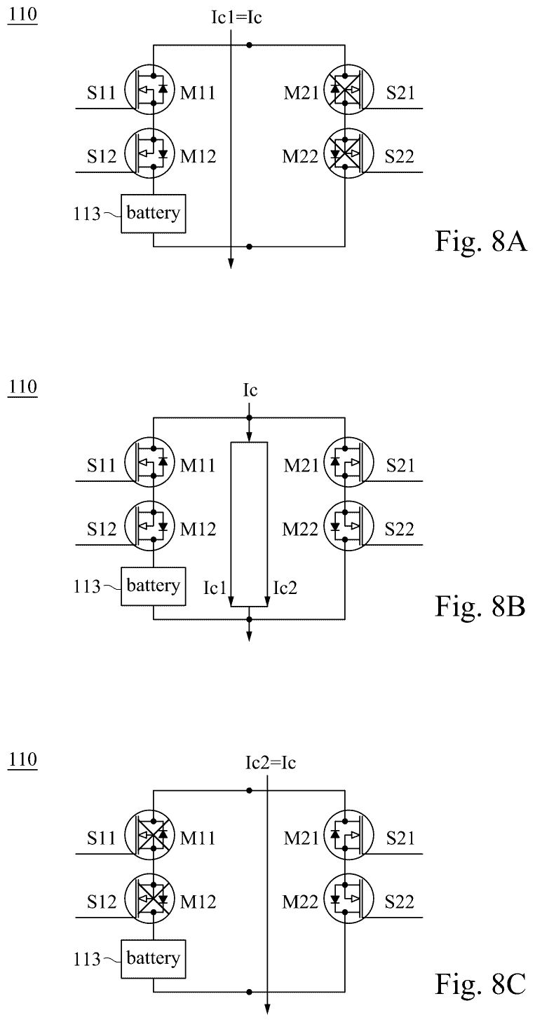

Please refer to FIG. 8A to FIG. 8C. FIG. 8A to FIG. 8C depict schematic diagrams corresponding to the battery charging and discharging system in FIG. 7 in a charge test according to some embodiments of the present disclosure.

Taking the bypass module 110 as an example, the bidirectional power supply 130 provides the charge current Ic to charge the battery 113 in the charge operation. The charge current Ic is a sum of the charge current Ic1 flowing through the current path P1 and the charge current Ic2 flowing through the current path P2.

Specifically, as shown in FIG. 8A, the transistors M11 and M12 are turned on and have low impedances, and the transistors M21 and M22 are turned off and have extremely high impedances, so that the charge current Ic flows as the charge current Ic1 flowing through the current path P1 to charge the battery 113.

Then, when the battery 113 has been charged to a certain level and needs to be disconnected from the charge current, a conduction state of each of the transistors M11 and M12 is adjusted by decreasing electrical potential of each of the signals S11 and S12. As shown in FIG. 8B, the impedance of each of the transistors M11 and M12 gradually increases and the current value of the charge current Ic1 gradually changes from a first current value to zero. At the same time, a conduction state of each of the transistors M21 and M22 is adjusted by rising electrical potential of each of the signals S21 and S22, and the impedance of each of the transistors M11 and M12 gradually decreases and the current value of the charge current Ic2 gradually changes from zero to a second current value, that is, as shown in FIG. 8 C, the charge current Ic flows as the charge current Ic2 flowing through the current path P2. In some embodiments where the battery 113 is fully charged and needs to be disconnected from the charge current, each of the first current value and the second current value is equal to a current value of the charge current Ic.

With the configurations provided in the present case as described above, during a process of disconnecting the battery from the charge current, due to the impedance suppression of the two current paths of the bypass module 110, a inrush current of the charging current Ic caused by the switching of the transistors M11 and M12 and the transistors M21 and M22 is reduced and a transient state is shortened.

On the contrary, some methods adopt simultaneous disconnection of two paths in the charge module to switch the transmission path of the charge current, and high-frequency switching speeds are utilized to achieve the switching of transistors to prevent the current interruption from being too long. However, this hard switching results in a significant inrush current—up to 300 amperes—to appear in the charge loop at the moment of switching. The inrush current causes damage to devices in the loop, such as power supplies, switching transistors and batteries. Compared to the aforementioned methods, the configuration provided in this application can suppress the inrush current to an order of 1 ampere, thereby greatly improving a reliability of devices in the battery charging and discharging system.

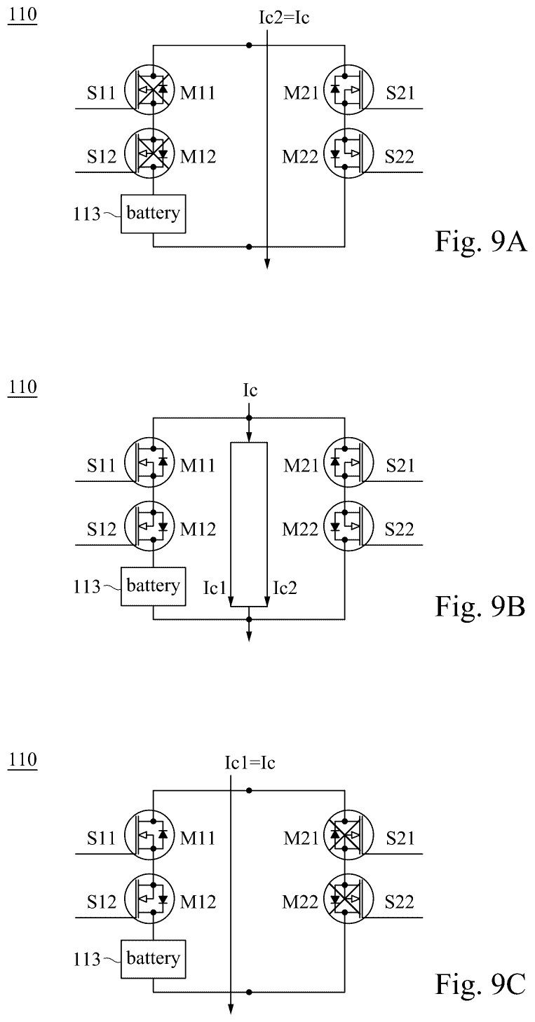

In some embodiments, after the battery 113 passes through the charge operation and the transistors M11 and M12 in the resistor unit 111 are turned off, a charging quality of the battery 113 does not meet a standard and needs to be recharged. The battery charging and discharging system 70 can switch from transmitting the charge current Ic through the current path P2 to transmitting the charge current Ic through the current path P1 to recharge the battery 113 as shown in the embodiments in FIG. 9A to FIG. 9C.

Please refer to FIG. 9A to FIG. 9C. FIG. 9A to FIG. 9C depict schematic diagrams corresponding to the battery charging and discharging system in FIG. 7 in a charge test according to some embodiments of the present disclosure.

Initially, as shown in FIG. 9A, when the transistors M21 and M22 are turned on and the transistors M11 and M12 are turned off, the charge current Ic as the charge current Ic2 flows through the current path P2.

Then, in the embodiments in FIG. 9B to FIG. 9C, the impedances of the transistors M21 and M22 are gradually increased and the current value of the charge current Ic2 gradually changes from the first current value to zero. At the same time, the impedances of the transistors M11 and M12 are gradually decreased and the current value of the charge current Ic1 gradually changes from zero to the second current value, so that, as shown in FIG. 9C, the charge current Ic as the charge current Ic1 flows through the current path P1 to recharge the battery 113.

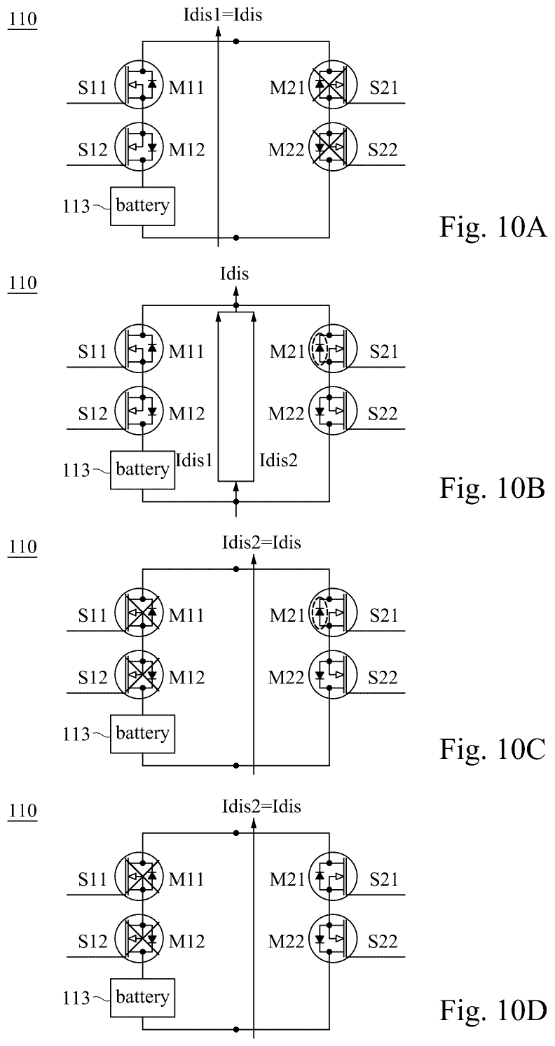

Please refer to FIG. 10A to FIG. 10D. FIG. 10A to FIG. 10D depict schematic diagrams corresponding to the battery charging and discharging system in FIG. 7 in a discharge test according to some embodiments of the present disclosure.

Taking the bypass module 110 as an example, the bidirectional power supply 130 provides a discharge demand instruction for the battery 113. Then, the battery 113 outputs a discharge current Idis in response to the discharge demand instruction, in which the discharge current Idis is a sum of a discharge current Idis1 flowing through the current path P1 and a discharge current Idis2 flowing through the current path P2.

As shown in FIG. 10A, the transistors M11 and M12 are turned on and the transistors M21 and M22, so that the discharge current Idis as the discharge current Idis1 flows through the current path P1.

Then, when the battery 113 has been discharged to a certain level and needs to be disconnected from the discharge current, firstly, as shown in FIG. 10B to FIG. 10C, the impedances of the transistors M11 and M12 are increased by gradually turning off the transistors M11 and M12, so that the current value of the discharge current Idis1 gradually changes from the third current value to zero. At the same time, the transistor M22 is gradually turned on in response to the signal S22 having a rising electrical potential, thereby reducing the impedance of the transistor M22. The transistor M21 responds to the signal S21 with a low electrical potential so that the discharge current Idis2 flows through its parasitic diode. Continued in FIG. 10D, by the transistor M21 being responsive to the signal S21 with a high electrical potential, the current value of the discharge current Idis2 gradually changes from zero to the fourth current value, and the discharge current Idis as the discharge current Idis2 flows through the current path P2.

Similar to the embodiments of the charge operation, with the configurations provided in the present application as described above, due to the suppression of the two sets of impedances of the bypass module 110, a inrush current of the discharge current Idis induced by the switching of the transistors M11 and M12 and the transistors M21 and M22 is greatly reduced and a transient state is shortened.

In addition, compared with the charge operation, in order to short circuiting the battery 113 due to switching during discharge, the transistor M21 is controlled and regarded as a diode operation until a phase commutation action of the discharge current Idis is completed (see FIG. 10D).

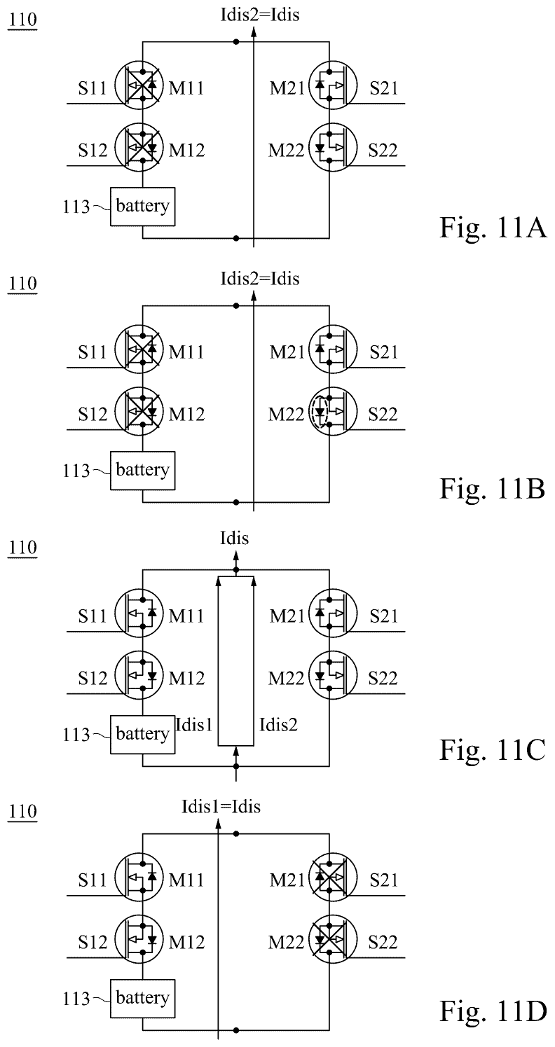

In some embodiments, after the battery 113 passes through the discharge operation and the transistors M11 and M12 in the resistor unit 111 are turned off, a discharging quality of the battery 113 does not meet a standard and needs to be recharged. The battery charging and discharging system 70 can switch from transmitting the discharge current Idis through current path P2 to re-charging battery 113 and transmitting the discharge current Idis through current path P1 as shown in embodiments of FIG. 11A to FIG. 11D.

Please refer to FIG. 11A to FIG. 11D. FIG. 11A to FIG. 11D depict schematic diagrams corresponding to the battery charging and discharging system in FIG. 7 in a discharge test according to some embodiments of the present disclosure.

Initially, as shown in FIG. 11A, when the transistors M21 and M22 are turned on and the transistors M11 and M12 are turned off, the discharge current Idis as the discharge current Idis2 flows through the current path P2.

Then, as shown in FIG. 11B, the transistor M21 is kept turned on and the transistor M22 is configured to respond to the signal S22 with a low electrical potential so that the discharge current Idis2 flows through its parasitic diode. Furthermore, as shown in FIG. 11C to FIG. 11D, by gradually turning on the transistors M11 and M12 to reduce the impedance of the transistors M11 and M12, the current value of the discharge current Idis1 gradually changes from zero to the third current value, and by gradually turning off the transistors M21 and M22 to increase the impedance of the transistors M21 and M22, the current value of the discharge current Idis2 gradually changes from the fourth current value to zero, and the battery 113 is discharged again and the discharge current Idis is transmitted through the current path P1.

Configurations of FIG. 1 to FIG. 11D are given for illustrative purposes. Various other implementations of FIG. 1 to FIG. 11D are within the expected scope of the present invention. For example, in some embodiments, the battery charging and discharging system may include more than two bypass modules coupled in series with each other, and have a operation mode similar to embodiments in FIG. 1 to FIG. 11D.

In addition, in some embodiments of the present disclosure, the transistors in FIG. 7 can be P-type transistors, and the battery charging and discharging system uses signals with opposite phases to those shown in FIG. 8A to FIG. 11D (such as CS11 to CS12, CS21 to CS22, CS31 to CS32, CS41 to CS42 and their corresponding signals generated to the transistors) to achieve charge and discharge operations as shown in FIG. 8A to FIG. 11D.

In summary, the present application provides a battery charging and discharging system and operation method thereof to control resistances of resistor units in bypass modules to generate two corresponding impedances in the two current transmission paths, thereby suppressing inrush current when switching transmission paths, further improving a reliability of each component in the battery charging and discharging system, and improving work efficiency.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A battery charging and discharging system, comprising:
a bidirectional power supply configured to provide a charge current to charge a battery in a charge operation; and
a bypass module coupled between two terminals of the bidirectional power supply, wherein the bypass module comprises a first current path and a second current path that are coupled in parallel to each other, wherein the first current path comprises a first resistor unit and the battery coupled to the first resistor unit, wherein the second current path comprises a second resistor unit;
wherein the charge current is a sum of a first charge current flowing through the first current path and a second charge current flowing through the second current path, wherein an impedance of the first resistor unit is adjusted to gradually increase, and meanwhile an impedance of the second resistor unit is adjusted to gradually decrease, so that a current value of the first charge current gradually changes from a first current value to zero, and a current value of the second charge current gradually changes from zero to a second current value at the same time.

2. The battery charging and discharging system of claim 1, wherein each of the first current value and the second current value is equal to a current value of the charge current.

3. The battery charging and discharging system of claim 1, wherein in a discharge operation, the bidirectional power supply is further configured to provide a discharge demand instruction to the battery, wherein the battery outputs a discharge current in response to the discharge demand instruction, wherein the discharge current is a sum of a first discharge current flowing through the first current path and a second discharge current flowing through the second current path, wherein the impedance of the first resistor unit is adjusted to gradually increase, and meanwhile the impedance of the second resistor unit is adjusted to gradually decrease, so that a current value of the first discharge current gradually changes from a third current value to zero, and a current value of the second discharge current gradually changes from zero to a fourth current value at a same time.

4. The battery charging and discharging system of claim 3, wherein each of the third current value and the fourth current value is equal to a current value of the discharge current.

5. The battery charging and discharging system of claim 1, wherein the first resistor unit comprises a first transistor and a second transistor that are coupled in series, and
the second resistor unit comprises a third transistor and a fourth transistor that are coupled in series.

6. The battery charging and discharging system of claim 1, wherein the first resistor unit is a first variable resistor, and the second resistor unit is a second variable resistor.

7. A charging testing method of a battery charging and discharging system, wherein the charging testing method is configured for the battery charging and discharging system that has a bidirectional power supply and a bypass module, wherein the bypass module is coupled between two terminals of the bidirectional power supply and comprises a first current path and a second current path that are coupled in parallel to each other, the first current path comprises a first resistor unit and a battery coupled to the first resistor unit, and the second current path comprises a second resistor unit, wherein the charging testing method comprises:
providing, by the bidirectional power supply, a charge current to charge the battery in a charge operation, wherein the charge current is a sum of a first charge current flowing through the first current path and a second charge current flowing through the second current path; and
gradually increasing an impedance of the first resistor unit and gradually decreasing an impedance of the second resistor unit at the same time, so that a current value of the first charge current gradually changes from a first current value to zero and a current value of the second charge current gradually changes from zero to a second current value at the same time.

8. The charging testing method of claim 7, wherein each of the first current value and the second current value is equal to a current value of the charge current.

9. The charging testing method of claim 7, wherein the first resistor unit comprises a first transistor and a second transistor that are coupled in series,
wherein gradually increasing the impedance of the first resistor unit comprises:
decreasing electrical potential of signals transmitted to the first transistor and the second transistor.

10. The charging testing method of claim 9, the second resistor unit comprises a third transistor and a fourth transistor that are coupled in series,
wherein gradually increasing the impedance of the first resistor unit comprises:
increasing electrical potential of signals transmitted to the third transistor and the four transistor.

11. A discharging testing method of a battery charging and discharging system, wherein the discharging testing method is configured for the battery charging and discharging system that has a bidirectional power supply and a bypass module, wherein the bypass module is coupled between two terminals of the bidirectional power supply and comprises a first current path and a second current path that are coupled in parallel to each other, the first current path comprises a first resistor unit and a battery coupled to the first resistor unit, and the second current path comprises a second resistor unit, wherein the discharging testing method comprises:
providing, by the bidirectional power supply, a discharge demand instruction for the battery ;
outputting, by the battery, a discharge current in response to the discharge demand instruction, wherein the discharge current is a sum of a first discharge current flowing through the first current path and a second discharge current flowing through the second current path; and
gradually increasing an impedance of the first resistor unit and gradually decreasing an impedance of the second resistor unit at the same time, so that a current value of the first discharge current gradually changes from a first current value to zero and a current value of the second discharge current gradually changes from zero to a second current value at the same time.

12. The discharging testing method of claim 11, wherein each of the first current value and the second current value is equal to a current value of the discharge current.

13. The discharging testing method of claim 11, wherein the first resistor unit comprises a first transistor and a second transistor that are coupled in series,
wherein gradually increasing the impedance of the first resistor unit comprises:
decreasing electrical potential of signals transmitted to the first transistor and the second transistor.

14. The discharging testing method of claim 13, the second resistor unit comprises a third transistor and a fourth transistor that are coupled in series,
wherein gradually increasing the impedance of the first resistor unit comprises:
firstly increasing electrical potential of a first signal transmitted to the third transistor and keeping a second signal transmitted to the fourth transistor having a first electrical potential; and
secondly change the electrical potential of the second signal from the first electrical potential to a second electrical potential to turn on the fourth transistor.

15. The discharging testing method of claim 14, wherein the second electrical potential is greater than the first electrical potential.
